(19) United States
(12) Patent Application Publication
(10) Pub. No.: US 2007/0023227 A1
(43) Pub. Date: Feb. 1, 2007

(54) Rack boot

(75) Inventor: Hidehiko Inagaki, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/489,672

(22) Filed: Jul. 20, 2006

(30) Foreign Application Priority Data
Jul. 29, 2005 (JP) 2005-220696

(51) Int. Cl. B62D 5/06

(52) U.S. Cl. 180/428

(57) ABSTRACT

In a rack boot having a bellows portion, a cylindrical portion which is formed at one end of the bellows portion so as to be fixed to a tie-rod and a second cylindrical portion which is formed at the other end of the bellows portion so as to be fixed to a steering gearbox, the bellows portion is divided into a first bellows portion which extends from a third ridge of ridge portions resulting when the ridge portions are counted from an end portion of the bellows portion which lies to the second cylindrical portion to the other end portion thereof which lies to the first cylindrical portion and a second bellows portion which extends from the third ridge to the end portion thereof which lies to the second cylindrical portion, and at least the first bellows portion is formed into a tapered shape.

### BACKGROUND OF THE INVENTION

1. Field of the Invention

The present invention relates to a steering boot which is used on a motor vehicle.

2. Related Art

A rack boot is a member which covers a ball joint between a steering gearbox and a tie-rod of a motor vehicle, and a general rack boot which is referred to as a rack boot or a steering rack boot is shown exemplarily in FIGS. 8 to 11, so as to describe the shape of the general rack boot below. FIG. 8 is an axially sectional view which exemplarily shows the general rack boot. FIGS. 9 and 8 are enlarged views of a main part of the general rack boot. FIG. 10 is an enlarged view of the main part of the general rack boot which shows exemplarily a state in which the general rack boot is compression deformed in an axial direction. FIG. 11 is an explanatory view which shows exemplarily a state in which the general rack boot is compression deformed while swinging largely.

As shown in FIGS. 8 and 9, a rack boot is made up of a bellows portion 101, a second cylindrical portion 102 and a first cylindrical portion 103. The second cylindrical portion 102 and the first cylindrical portion 103 are both formed into a cylindrical shape. The second cylindrical portion 102 is made larger in diameter than the first cylindrical portion 103. The bellows portion 101 is formed into a hollow shape (a so-called bellows shape) in which ridge portions 104 and recess portions 105 are continue alternately in such a manner that the ridge portion 104 and the recess portion 105 are connected together by an inclined wall portion 106 and can expand and contract. One end of the bellows portion 101 is formed integrally with the second cylindrical portion 102 whereas the other end thereof is formed integrally with the first cylindrical portion. The second cylindrical portion 102 is attached to a steering gearbox 170. The first cylindrical portion 103 is attached to a tie-rod 171. The bellows portion 101 covers a steering member which is made up of a rack bar 172 which extends from the steering gearbox 170, the tie-rod 171, a ball joint 173 which couples the rack bar 172 and the tie-rod 171 together, and the like.

The steering member is connected to a steering wheel (not shown) via a steering column (not shown) and a universal joint (not shown). When the driver turns the steering wheel, the rotation of the steering wheel is transmitted to a pinion (not shown) which is incorporated in the steering gearbox 170. In addition, the rack bar 172, which is similarly incorporated in the steering gearbox 170 and which meshes with the pinion, protrudes from (or sinks into) the steering gearbox 170. Thus, the rack boot is expansion or compression deformed so as to follow the operation of the steering wheel by the driver so that the rack boot can cover the steering member.

Incidentally, when the rack boot is compression deformed, adjacent inclined wall portions 106 of the rack boot are brought into press contact with each other, as shown in FIG. 10. A load imparted to the rack boot when the rack boot is compression deformed (hereinafter, referred to as a compression load) is increased by virtue of the press contact of the inclined wall portions 106. This compression load increases drastically at a point in time where the adjacent inclined wall portions 106 are brought into contact with each other. In addition, since the adjacent ridge portions 104 are brought into press contact with each other when the rack boot is compression deformed largely, the compression load imparted to the rack boot increases very much. When the compression load imparted to the rack boot becomes too large, there is caused a drawback in which the steering feel of the steering wheel is deteriorated.

In addition, when the tie-rod 171 swings largely relative to the ball joint 173, following the swing of the tie-rod 171, the rack boot swings largely. In the event that the rack sinks largely into the steering gearbox 170 at the same time as the rack boot swings largely, the rack boot is compression deformed while swinging largely. As this occurs, the rack boot is deformed abnormally as shown in FIG. 11. Namely, part of the rack boot is buckled and sags downwards in a direction of the time rod 171, while a portion of the rack boot which is adjacent to the buckled portion projects largely towards an outer circumferential side thereof. When the rack boot is buckled, there is caused a drawback in which the buckled portion of the rack boot is held between the steering gearbox 10 and the ball joint 173. In addition, when the portion of the rackboot which is adjacent to the buckled portion projects largely towards the outer circumferential side thereof, the external shape of the rack boot is increased, and there is caused a drawback in which the rack boot comes to interfere with various members which are disposed adjacent to the rack boot.

In view of the drawbacks that have been described above, techniques have been proposed for preventing the abnormal deformation of the rack boot (for example, refer to Patent Document No. 1). A rack boot disclosed in Patent Document No. 1 is such as to prevent the abnormal deformation of the rack boot by improving the folding properties of a bellows portion. In the rack boot disclosed in Patent Document No. 1, the bellows portion is made up of a central portion (a central bellows portion) and two tapered bellows portions which are formed on both ends of the central bellows portion. Each tapered bellows portion is formed into a tapered shape by being formed larger in diameter at a boundary portion to the central bellows portion, while being formed smaller in diameter at a boundary portion to a first cylindrical portion or a second cylindrical portion. In this rackboot, when the rackboot is compression deformed, firstly, the tapered bellows portions are compressed, and then, the central bellows portion is compressed. Since the tapered bellows portions are compressed earlier than the central bellows portion, there can be eliminated a case where the central bellows portion sags in the direction of a ball joint, and hence, the drawback can be eliminated where the central bellows portion is held between the steering gearbox and the ball joint. In addition, since the rack boot disclosed in Patent Document No. 1 is such that the tapered bellows portions are formed into the tapered shape, superior folding properties can be provided. Consequently, it is considered that with this rack boot, the compression load is reduced.

Even with the rack boot that is disclosed in Patent Document No. 1, the drawback related to the buckling produced when the rack is compression deformed while swinging largely could not be eliminated. Namely, a region (an attaching region) on a straight line which connects the first cylindrical portion with the second cylindrical portion is largely contracted when the rack boot is compression deformed while swinging largely. The bellows portion is folded in such a manner as to be accommodated within the attaching region. Incidentally, when the attaching region becomes too small, an axial overall length of the folded bellows portion cannot be accommodated within the attaching region. As this occurs, the bellows portion attempts to escape from the attaching region and is eventually buckled. As is disclosed in Patent Document No. 1, even with the rack boot having the central bellows portion and the two tapered bellows portions, the buckling is similarly caused when the attaching region becomes too small. In particular, in this case, a large buckling deformation is caused in the central bellows portion where the outside diameter is large. Consequently, there is still caused the buckling in the rack boot disclosed in Patent Document No. 1, and the drawbacks attributed to the buckling of the rack boot still remain unsolved in which the buckled portion of the rack boot is held between the steering gearbox and the ball joint and the rack boot comes to interfere with various members which are disposed adjacent to the rack boot.

[Patent Document No. 1] JP-A-63-40278

### SUMMARY OF THE INVENTION

The invention was made in view of the situations, and an object thereof is to provide a rack boot which can not only reduce the compression load but also avoid the abnormal deformation thereof.

With a view to solving the problem, according to the invention, there is provided a rack boot including a hollow bellows portion in which radially outward rising ridge portions and radially inward sinking recess portions are formed alternately and continuously while the ridge portion and the recess portion which are adjacent to each other are connected together by an inclined wall portion, a first cylindrical portion formed at one end of the bellows portion in such a manner as to be fixed to a tie-rod and a second cylindrical portion formed at the other end of the bellows portion in such a manner as to be fixed to a steering gear box, wherein the bellows portion has a first bellows portion which makes up a portion extending from a third ridge of the ridge portions resulting when the ridge portions are counted from an end portion of the bellows portion which lies to the second cylindrical portion to the other end portion thereof which lies to the first cylindrical portion and a second bellows portion which makes up a portion extending from the third ridge to the end portion which lies to the second cylindrical portion, and wherein at least the first bellows portion is formed into a tapered shape in which an outside diameter of at least the ridge portions is such that an outside diameter of the ridge portion is made smaller than an outside diameter of the ridge portion which lies closer to the second cylindrical portion side.

The rack boot of the invention preferably includes any of the following configurations (1) to (4). The rack boot desirably includes more than one of the following configurations (1) to (4).

(1) The second bellows portion is formed into the tapered shape.

(2) In the first bellows portion, an outside diameter of the recess portions is such that an outside diameter of the recess portion is made smaller than an outside diameter of the recess portion which lies closer to the second cylindrical portion side.

(3) In the first bellows portion, a difference in outside diameter between the ridge portions which lie adjacent to each other is in the range of 1 mm to 4 mm.

(4) In the first bellows portion, a difference in outside diameter between the recess portions which lie adjacent to each other is in the range of 1 mm to 4 mm.

The rack boot of the invention is such that at least the first bellows portion is formed into the tapered shape in which the outside diameter of at least the ridge portions is such that the outside diameter of the ridge portion is made smaller than the outside diameter of the ridge portion which lies closer to the second cylindrical portion side. Namely, the outside diameter of at least the first bellows portion decreases gradually towards the first cylindrical portion side. Due to this, in at least the first bellows portion of the rack boot of the invention, there occurs no case where the adjacent ridge portions are brought into press contact with each other even during the compression deformation, and hence, the compression load is reduced largely. In addition, when used herein, a tapered shape is a concept which includes the tapered shape in which the outside diameter of the ridge portion is made smaller than the outside diameter of the ridge portion which lies closer to the second cylindrical portion side, and the outside diameter of the recess portion is made smaller than the outside diameter of the recess portion which lies closer to the second cylindrical portion side.

In addition, the rack boot of the invention does not have a central bellows portion like the one of the rack boot of Patent Document No. 1 that has been described above. In addition, in at least the first bellows portion, the outside diameter of the ridge portions decreases gradually from the second cylindrical portion side where almost no deformation is produced even when the rack boot swings towards the first cylindrical portion side. The axial overall length of the folded bellows portion becomes shorter due to the outside diameter of the ridge portions decreasing gradually from the second cylindrical portion side towards the first cylindrical portion side. Consequently, even when the attaching region is largely contracted as has been described above, the axial overall length of the folded bellows portion is allowed to be accommodated within the attaching region. Due to this, there occurs no case where a buckling is produced in the bellows portion. Consequently, there is no chance of causing the drawback in which the buckled portion of the rack boot is held between the steering gearbox and the ball joint and the drawback in which the rack boot comes to interfere with various members which are disposed adjacent to the rack boot when the rack boot is compression deformed while swinging largely.

In addition, a portion of the bellows portion which extends from the end portion thereof which lies to the second cylindrical portion to a second ridge of the ridge portions resulting when the ridge portions are counted from the end portion which lies to the second cylindrical portion deforms little even when the rack boot is compression deformed while swinging largely. This is because, as has been described above, the steering gearbox to which the second cylindrical portion is fixed stands still even when the tie-rod swings. Consequently, in the rack boot of the invention, at least the first bellows portion, that is, the portion of the bellows portion which extends from the third ridge of the ridge portions resulting when the ridge portions are counted from the end portion of the bellows portion which lies to the second cylindrical portion to the end portion thereof portion which lies to the first cylindrical portion only has to be tapered.

In the event that the rack boot of the invention includes the configuration described under (1) above, even in the second bellows portion, the ridge portions are not brought into press contact with each other, and hence, the compression load is reduced further. In addition, since the axial overall length of the folded bellows portion including the second bellows portion is made shorter, the buckling of the bellows portion can be avoided in a further ensured fashion.

In the event that the rack boot of the invention includes the configuration described under (2) above, when the rack boot is compression deformed while swinging largely, neither the ridge portions are brought into press contact with each other nor the recess portions are brought into press contact with each other. Consequently, the compression load is reduced further and the buckling of the bellows portion is avoided in the further ensured fashion.

In the event that the rack boot of the invention includes the configuration described under (3) above, the adjacent ridge portions are disposed in such a manner as to be spaced apart from each other in a diametrical direction (in a direction of the outside diameter of the rack boot). Consequently, when the rack boot is compression deformed while swinging largely, the drawback is avoided in the further ensured fashion in which the adjacent ridge portions are brought into press contact with each other, and consequently, the compression load is reduced sufficiently, the buckling of the bellows portion being avoided in the further ensured fashion.

In the event that the rack boot of the invention includes the configuration described under (4) above, the adjacent recess portions are disposed in such a manner as to be spaced apart from each other in the diametrical direction. Consequently, when the rack boot is compression deformed while swinging largely, the drawback is avoided in the further ensured fashion in which the adjacent recess portions are brought into press contact with each other, and consequently, the compression load is reduced sufficiently, the buckling of the bellows portion being avoided in the further ensured fashion.

### BRIEF DESCRIPTION OF THE DRAWINGS

FIG. 1 is an axially sectional view showing exemplarily a rack boot of Embodiment 1.

FIG. 2 is an enlarged view of a main part of FIG. 1.

FIG. 3 is an enlarged view of the main part of the rack boot of Embodiment 1 which shows exemplarily a state in which the rack boot is compression deformed in an axial direction thereof.

FIG. 4 is an explanatory view showing exemplarily a state in which the rack boot of Embodiment 1 is compression deformed while swinging largely.

FIG. 5 is an axially sectional view showing exemplarily a rack boot of Embodiment 2.

FIG. 6 is a graph showing the results of compression load measuring tests.

FIG. 7 is a graph showing the results of rack boot outside diameter verification tests during compression and swinging.

FIG. 8 is an axially sectional view showing exemplarily a general rack boot.

FIG. 9 is an enlarged view of a main part of FIG. 8.

FIG. 10 is an enlarged view of the main part of the general rack boot which shows exemplarily a state in which the rack boot is compression deformed in an axial direction thereof.

FIG. 11 is an explanatory view showing exemplarily a state in which the general rack boot is compression deformed while swinging largely.

### DETAILED DESCRIPTION OF THE PREFERRED EMBODIMENTS

A rack boot of the invention will be described below based on the accompanying drawings.

### Embodiment 1

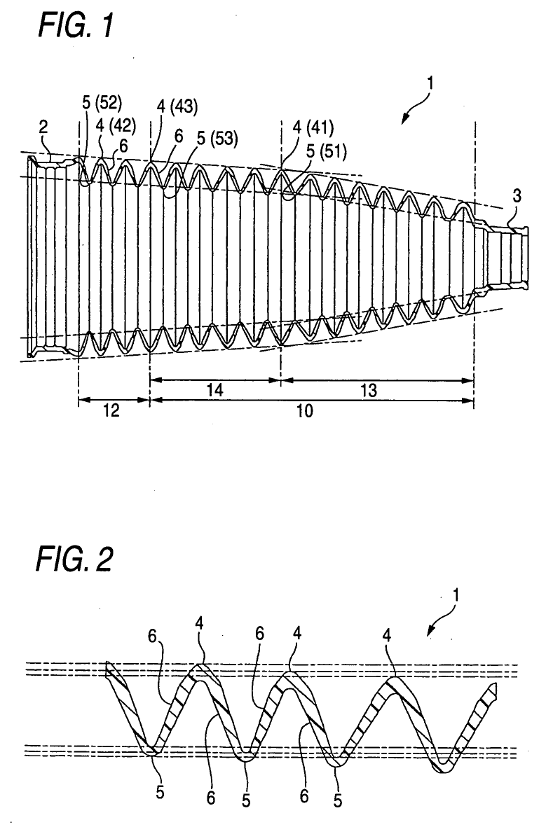

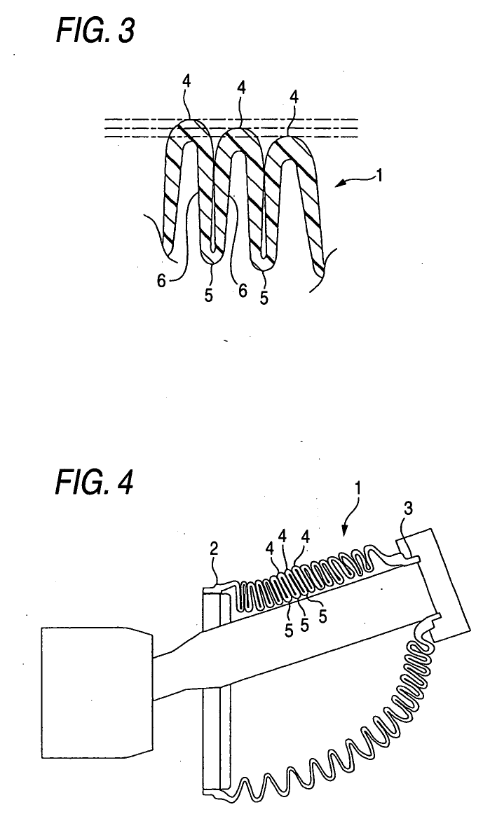

A rack boot of Embodiment 1 includes the configurations described under (1) to (4). An axially sectional view is shown in FIG. 1 which shows the rack boot of Embodiment 1, and an enlarged view of a main part of FIG. 1 is shown in FIG. 2. An explanatory view of the main part of the rack boot of Embodiment 1 is shown in FIG. 3 which shows exemplarily a state in which the rack boot is compression deformed in an axial direction thereof. An explanatory view is shown in FIG. 4 which shows exemplarily a state in which the rack boot of Embodiment 1 is compression deformed while swinging largely.

As shown in FIGS. 1 and 2, the resin boot of Embodiment 1 includes a bellows portion 1, a second cylindrical portion 2 and a first cylindrical portion 3. The bellows portion 1, the second cylindrical portion 2 and the first cylindrical portion 3 are formed integrally through blowmolding. The second cylindrical portion 2 is formed into a ring shape and is attached to a steering gearbox (not shown). The first cylindrical portion 3 is formed into a ring shape which is smaller in diameter than the second cylindrical portion 2 and is attached to a tie-rod (not shown).

The bellows portion 1 is formed into a hollow shape which establishes a communication between the second cylindrical portion 2 and the first cylindrical portion 3. Pluralities of radially outward rising ridge portions 4 and radially inward sinking recess portions 5 are formed on the bellows portion 1. The ridge portions 4 and the recess portions 5 are disposed alternately and continuously in such an order of ridge portion 4, recess portion 5, ridge portion 4, recess portion 5, . . . . The bellows portion 1 is made up of a first bellows portion 10 which is a portion lying to the first cylindrical portion 3 side and a second bellows portion 12 which is a portion lying to the second cylindrical portion 2 side. A portion of the bellows portion 1 which extends from a third ridge of the ridge portions resulting when the ridge portions are counted from an end portion of the bellows portion which lies to the second cylindrical portion 2 to the other end portion thereof which lies to the first cylindrical portion 3 constitutes the first bellows portion 10. A portion of the bellows portion 1 which extends from the third ridge of the bellows portion resulting when the ridge portions are counted from the end portion which lies to the second cylindrical portion 2 to the end portion which lies to the second cylindrical portion 2 constitutes the second bellows portion 12. Hereinafter, an Xth ridge of the ridge portions resulting when the ridge portions are counted from the end portion of the bellows portion 1 which lies to the second cylindrical portion 2 is simply referred to as an Xth ridge.

The first bellows portion 10 includes further a small diameter side bellows portion 13 which is a portion lying to the first cylindrical portion 3 and a large diameter side bellows portion 14 which is a portion lying to the second bellows portion 12. A portion of the bellows portion 1 which extends from an eighth ridge to the end portion of the bellows portion 1 which lies to the first cylindrical portion 3 constitutes the small diameter side bellows portion 13. A portion of the bellows portion 1 which extends from the third ridge to the eighth ridge constitutes the large diameter side bellows portion 14. The first bellows portion 10 covers an outer circumference of a ball joint (not shown).

The first bellows portion 10 is formed into a tapered shape in which the outside diameter of the ridge portions 4 is such that an outside diameter of the ridge portion 4 is made smaller than an outside diameter of the ridge portion 4 which lies closer to the second cylindrical portion 2 side and the outside diameter of the recess portions 5 is such that an outside diameter of the recess portion 5 is made smaller than an outside diameter of the recess portion 5 which lies closer to the second cylindrical portion 2 side. Namely, in the first bellows portion 10, the outside diameter of the ridge portions 4 and the outside diameter of the recess portions 5 are made to decrease gradually towards the first cylindrical portion 3. A difference in outside diameter between the ridge portions 4 which are adjacent to each other is larger in the small diameter side bellows portion 13 than in the large diameter side bellows portion 14, and a difference in outside diameter between the recess portions 5 which are adjacent to each other is larger in the small diameter side bellows portion 13 than in the large diameter side bellows portion 14. Hereinafter, the difference in outside diameter between the adjacent ridge portions 4 is referred concisely to as a ridge diameter difference. In addition, the difference in outside diameter between the adjacent recess portions 5 is referred concisely to as a recess diameter difference.

The ridge diameter difference in the small diameter side bellows portion 13 is in the range of 3 to 4 mm. The recess diameter difference in the small diameter side bellows portion 13 is in the range of 2 to 3 mm. The ridge diameter difference in the large diameter side bellows portion 14 is 1 mm. The recess diameter difference in the large diameter side bellows portion 14 is 1 mm. In the small diameter side bellows portion 13, the outside diameter of the ridge portion 4 (41) which lies closest to the second cylindrical portion 2 side is 59 mm. In the small diameter side bellows portion 13, the outside diameter of the recess portion 5 (51) which lies closest to the second cylindrical portion 2 side is 44 mm. In the large diameter side bellows portion 14, the outside diameter of the ridge portion 4 (43) which lies closest to the second cylindrical portion 2 side is 64 mm. In the large diameter side bellows portion 14, the outside diameter of the recess portion 5 (53) which lies closest to the second cylindrical portion 2 side is 48 mm.

The second bellows portion 12 is formed into a tapered shape in which the outside diameter of the ridge portions 4 is such that an outside diameter of the ridge portion 4 is made smaller than an outside diameter of the ridge portion 4 which lies closer to the second cylindrical portion 2 side and the outside diameter of the recess portions 5 is such that an outside diameter of the recess portion 5 is made smaller than an outside diameter of the recess portion 5 which lies closer to the second cylindrical portion 2 side. Namely, in the rack boot of Embodiment 1, both the first bellows portion 10 and the second bellows portion 12 are formed into the tapered shape. The ridge diameter difference in the second bellows portion 12 is 1 mm. The recess diameter difference in the second bellows portion 12 is 1 mm. The outside diameter of the ridge portion 4 (42) which lies closest to the second cylindrical portion 2 in the second bellows portion 12 side is 66 mm. The outside diameter of the recess portion 5 (52) which lies closest to the second cylindrical portion 2 side in the second bellows portion 12 is 51 mm.

In the rack boot of Embodiment 1, the whole of the bellows portion 1 is formed into a tapered shape, and the ridge portions which lie adjacent to each other are disposed in such a manner as to sequentially deviate from each other in a diametrical direction of the rack boot. Consequently, as shown in FIG. 3, when the rack boot is compression deformed in an axial direction thereof, the adjacent ridge portions 4 are not brought into press contact with each other. Consequently, as shown in FIG. 4, even when the rack boot is compression deformed while swinging largely, the drawback is avoided in which the adjacent ridge portions 4 are brought into press contact with each other, whereby the compression load is reduced, and the buckling of the bellows portion 1 is avoided. In addition, in the rack boot of Embodiment 1, the recess portions 5 which lie adjacent to each other in the bellows portion 1 (the first bellows portion 10 and the second bellows portion 12) are disposed in such a manner as to sequentially deviate from each other in the diametrical direction of the rack boot. Consequently, as shown in FIG. 3, when the rack boot is compression deformed in the axial direction thereof, the adjacent recess portions 5 are not brought into press contact with each other, either. Consequently, as shown in FIG. 4, even when the rack boot is compression deformed while swinging largely, the drawback is avoided in which the adjacent recess portions 5 are brought into press contact with each other, whereby the compression load is reduced, and the buckling of the bellows portion 1 is avoided.

Note that as the ridge diameter difference and the recess diameter difference becomes larger, the drawbacks in which the adjacent ridge portions 4 and the adjacent recess portions 5 are brought into press contact with each other, respectively, can be avoided in a further ensured fashion.

In the rack boot of Embodiment 1, the ball joint is incorporated in the vicinity of the eighth ridge in the bellows portion 1. Consequently, the portion of the bellows portion 1 which lies closer to the first cylindrical portion 3 than the eighth ridge does not have to be formed so large in diameter. Consequently, in the rack boot of Embodiment 1, the ridge diameter difference and the recess diameter difference can be made larger in the portion of the bellows portion 1 which lies closer to the first cylindrical portion 3 than the eighth ridge (the small diameter side bellows portion 13) than in the portion which lies closer to the second cylindrical portion 2 than the eighth ridge (the large diameter side bellows portion 14 and the second bellows portion 12). The larger the ridge diameter difference and the recess diameter difference become, the more smoothly the bellows portion 1 can be folded, and the buckling of the bellows portion 1 can be avoided in a further ensured fashion. Consequently, in the rack boot of Embodiment 1, the buckling of the bellows portion 1 can be avoided in the further ensured fashion by providing the small diameter side bellows portion 13 in the first bellows portion 10.

In addition, the small diameter side bellows portion 13 may only has to be set based on the position where the ball joint is incorporated in the rack boot. Namely, the small diameter side bellows portion 13 may be provided at a portion which lies closer to the first cylindrical portion 3 side than the position where the ball joint is incorporated based on the ball joint incorporating position. The outside diameter of the portion of the bellows portion 1 where the ball joint is incorporated can be set properly according to the outside diameter of the ball joint. The outside diameter of the first cylindrical portion 3 can be set properly according to the outside diameter of the tie-rod. The outside diameter of the second cylindrical portion 2 can be set properly according to the outside diameter of the steering gearbox. In addition, the ridge diameter difference and recess diameter difference in the small diameter side bellows portion 13 may be set according to the outside diameter of the portion of the bellows portion 1 where the ball joint is incorporated and the outside diameter of the first cylindrical portion 3. The ridge diameter difference and recess diameter difference in the large diameter side bellows portion 14 and the second bellows portion 12 may be set according to the outside diameter of the portion of the bellows portion 1 where the ball joint is incorporated and the outside diameter of the second cylindrical portion 2.

In the rack boot of Embodiment 1, the ridge diameter difference and recess diameter difference in the first bellows portion 10 differ between the small diameter side bellows portion 13 and the large diameter side bellows portion 14. Depending upon the shapes of the ball joint, the steering gearbox and the tie-rod, however, the ridge diameter recess and recess diameter difference in the small diameter side bellows portion 13 may be made the same as those in the large diameter side bellows portion 14. In addition, the ridge diameter difference and recess diameter difference in the first bellows portion 10 may be made the same as those in the second bellows portion 12. In this case, too, when the rack boot is compression deformed while swinging largely, the drawbacks can be avoided in which the adjacent ridge portions 4 and the adjacent recess portions 5 are brought into press contact with each other, respectively.

### Embodiment 2

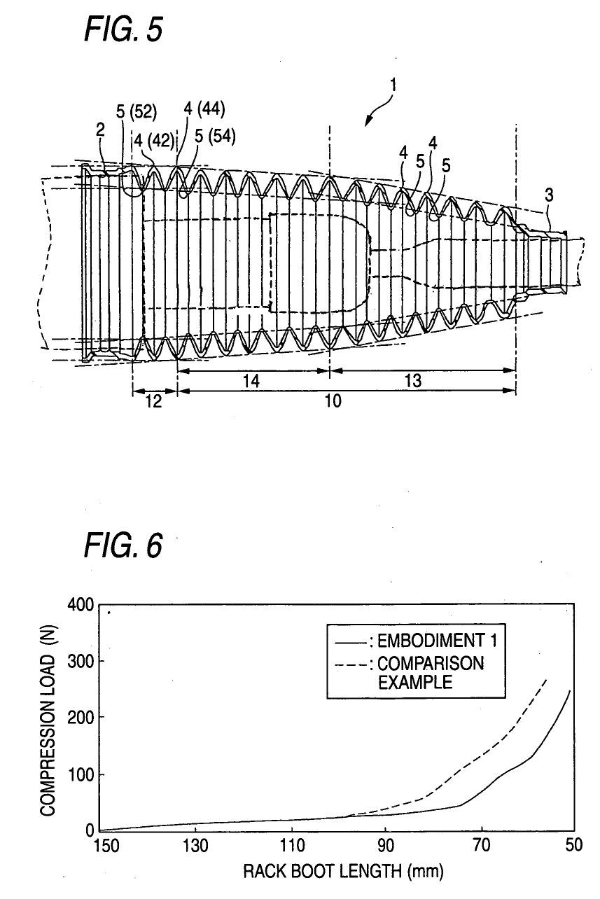

A rack boot of Embodiment 2 includes the configurations described under (2) to (4). An axially sectional view s shown in FIG. 5 which shows exemplarily the rack boot of Embodiment 2.

As shown in FIG. 5, the rack boot of Embodiment 2 includes a bellows portion 1, a second cylindrical portion 2 and a first cylindrical portion 3. The first cylindrical portion 3 and the second cylindrical portion 2 are the same as those of Embodiment 1. The bellows portion 1 is made up of a first bellows portion 10 and a second bellows portion 12. As with Embodiment 1, the first bellows portion 10 has a small diameter side bellows portion 13 and a large diameter side bellows portion 14. The small diameter side bellows portion 13 has a shape which is the same as that of Embodiment 1.

The large diameter side bellows portion 14 is formed into a tapered shape in which an outside diameter of ridge portions 4 is such that an outside diameter of the ridge portion 4 is made smaller than an outside diameter of the ridge portion 4 which lies closer to the second cylindrical portion 2 side and an outside diameter of recess portions 5 is such that an outside diameter of the recess portion 5 is made smaller than an outside diameter of the recess portion 5 which lies closer to the second cylindrical portion 2 side. The ridge diameter difference in the large diameter side bellows portion 14 is 1 mm, and the recess diameter difference therein is 1 mm. The outside diameter of the ridge portion 4 (42) which lies closest to the second cylindrical portion 2 side in the large diameter side bellows portion 14 is 65 mm. The outside diameter of the recess portion 5 (52) which lies closest to the second cylindrical portion 2 side in the large diameter side bellows portion 14 is 49 mm. In the rack boot of Embodiment 2, only the first bellows portion 10 is formed into the tapered shape.

The second bellows portion 12 is formed such that the outside diameters of a first ridge portion 4 (42) and a second ridge portion 4 (44) are the same and the outside diameters of a first recess portion 5 (52) and a second recess portion 5 (54) are the same. In the second bellows portion 12, the outside diameter of the ridge portions 4 is 65 mm, and the outside diameter of the recess portions 5 is 49 mm. In the second bellows portion 12, the outside diameter of the ridge portion 4 (42) which lies closest to the second cylindrical portion 2 is 65 mm. In the second bellows portion 12, the outside diameter of the recess portion 5 (52) which lies closest to the second cylindrical portion 2 is 49 mm.

In the rack boot of Embodiment 2, only the first bellows portion 10 is formed into the tapered shape. In addition, the outside diameters of the ridge portions (the first ridge portion 42 and the second ridge portion 44) of the second bellows portion 12 are the same, and the outside diameters of the recess portions 5 (the first recess portion 52 and the second recess portion 54) of the second bellows portion 12 are the same. As has been described above, a portion of the bellows portion 1 which extends from an end portion lying to the second cylindrical portion 2 to the second ridge of the ridge portions resulting when the ridge portions are counted from the end portion which lies to the second cylindrical portion 2 deforms little even when the rack boot is compression deformed while swinging largely. Consequently, while the rack boot of Embodiment 2 has the second bellows portion 12 which is not formed into a tapered shape, even when the rack boot is compression deformed while swinging largely, the drawbacks can be avoided in which the adjacent ridge portions 4 and the adjacent recess portions 5 are brought into press contact with each other, respectively. Consequently, also with the rack boot of Embodiment 2, the compression load is reduced and the buckling of the bellows portion 1 is avoided.

### Comparison Example

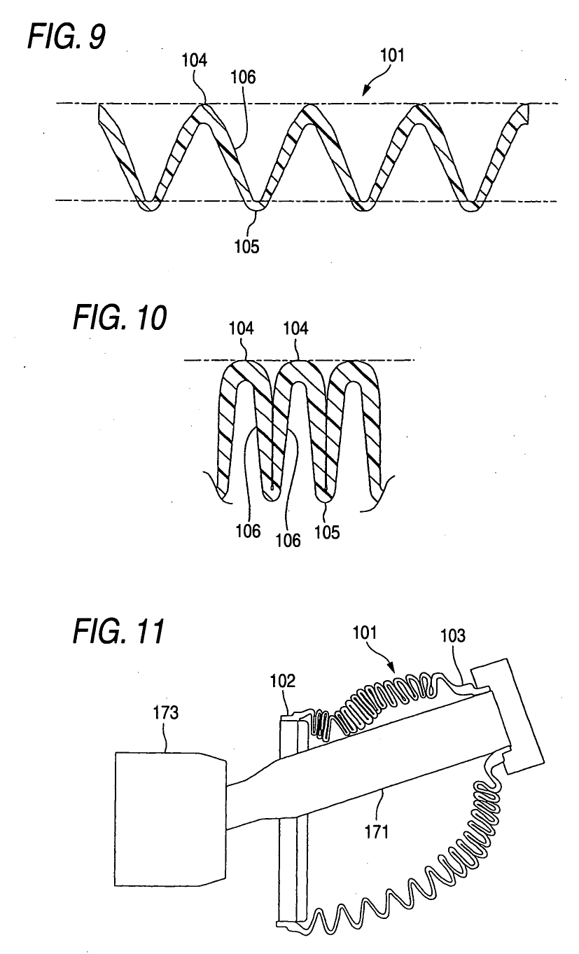

A rack boot of a comparison example is the conventional rack boot shown in FIGS. 8 to 11. In the rack boot of the comparison example, a bellows portion 101 has a first bellows portion 110 and a second bellows portion 112. The second bellows portion 112 is formed such that the outside diameter of a first ridge portion 104 (142) and the outside diameter of a second ridge portion 104 (144) are the same and the outside diameter of a first recess portion 105 (152) and the outside diameter of a second recess portion 105 (154) are the same. In the second bellows portion 112, the outside diameter of the ridge portions 104 is 66 mm, and the outside diameter of the recess portions 105 is 51 mm.

The first bellows portion 110 has a portion which extends from a tenth ridge to an end portion of thereof which lies to a first cylindrical portion 103 (a small diameter side bellows portion 113) and a portion which extends from the tenth ridge to the other end portion thereof which lies to the second bellows portion 112 (a large diameter side bellows portion 114). In the rack boot of the comparison example, of the first bellows portion 110, only the small diameter side bellows portion 113 is formed into a tapered shape. The large diameter side bellows portion 114 is formed such that the outside diameters of the ridge portions 104 are equal and the outside diameters of the recess portions 105 are equal, and the outside diameter of the ridge portions 104 and the outside diameter of the recess portions 105 of the large diameter side bellows portion 114 are the same as those of the second bellows portion 112.

The ridge diameter difference in the first bellows portion 110 is 4 mm, and the recess diameter difference therein is in the range of 3 to 4 mm. In the first bellows portion 110, the outside diameter of the ridge portion 104 (141) which lies closest to the second cylindrical portion 102 side is 66 mm. In the first bellows portion 110, the outside diameter of the recess portion 105 (151) which lies closest to the second cylindrical portion 102 side is 49 mm.

(Compression Load Measuring Tests)

A relationship between a load imparted to the rack boot when it is compressed and the length of the compressed rack boot was measured by mounting the rack boots of Embodiment 1 and the comparison example on a universal tensile tester and compressing the rack boots so mounted. The universal tensile tester includes a stationary table, a load cell, a constant temperature oven, a movable table and two fixtures. The movable tables reciprocates rectilinearly relative to the stationary table. One of the fixtures and the constant temperature oven are fixed to the movable table. The one of the fixtures and the constant temperature oven reciprocate in association with the reciprocating movement of the movable table. The load cell is fixed to the stationary table, and the other fixture is fixed to the load cell. The rack boots were accommodated in the constant temperature oven in such a state that the rack boots were assembled to tie-rods, ball joints and steering gearboxes. In addition, the steering gearboxes were fixed to the stationary table side fixture, while the tie-rods were fixed to the movable table side fixture. As this occurred, the rack boots were in such a state where neither expansion nor compression occurred (the overall length of the rack boots was 150 mm). When the movable table was moved towards the stationary table side in this state, the rack boots were compressed from the first cylindrical portion side towards the second cylindrical portion side. The traveling speed of the movable table then was a constant speed (100 mm/min). Loads imparted to the rack boots when they were compressed were measured by means of the load cell. Note that vent holes were formed in the second cylindrical portions of the rack boots in order to eliminate the effect of internal pressures resulting when the rack boots were compressed.

A graph is shown in FIG. 6 which shows the results of compression load measuring tests. In FIG. 6, the axis of abscissa represents lengths of the rack boots, and the axis of ordinates represents compression loads (N) imparted to the rack boots. As shown in FIG. 6, while a compression load resulting when the rack boot of the comparison example was compressed largely (when the length of the rack boot became short) is very large, a compression load resulting when the rack boot of Embodiment 1 was compressed largely is very small compared to the comparison example. For example, while a compression load resulting when the rack boot of the comparison example was compressed until it was compressed to 58 mm was 240 N, a compression load resulting when the rack boot of Embodiment 1 was compressed until it was compressed to 58 mm was 140N. It is seen from the results of the test that with the rack boot of the invention, the compression load is reduced largely compared to the conventional rack boot.

(Rack Boot Outside Diameter Verification Tests During Compression and Swinging)

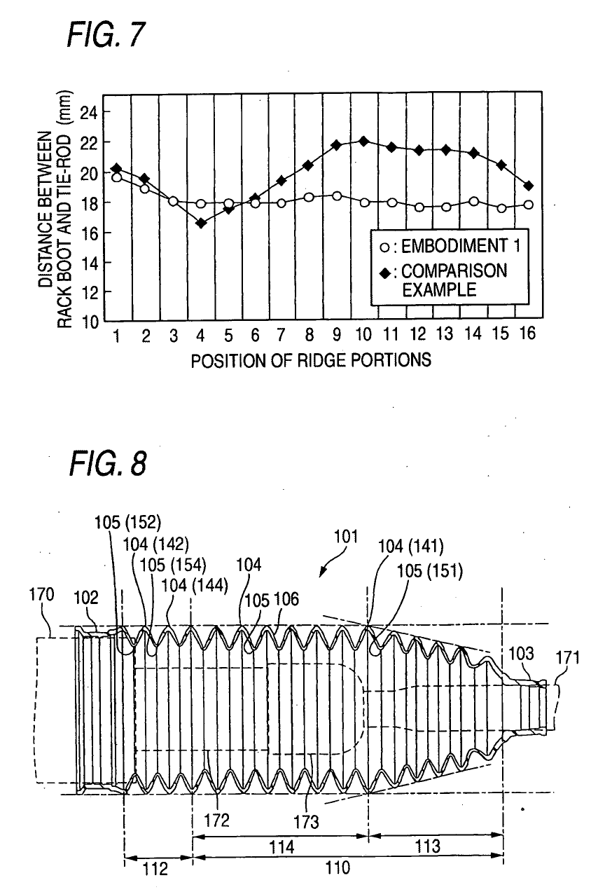

The rack boots of Embodiment 1 and the comparison example were mounted on the steering members, and the rack boots were compressed to a minimum set length while the tie-rods were caused to swing to their maximum levels, so as to measure distances between the rack boots and the tie-rods or rack bars which are attached coaxially to the tie-rods (hereinafter, referred simply to tie-rods). To be specific, a distance between an axial center of the tie-rod and an outer circumferential side apex of each ridge portion was measured. A graph is shown in FIG. 7 which shows the results of rack boot outside diameter verification tests during compression and swinging. In FIG. 7, the axis of abscissa represents positions of ridge portions which were measured. To be specific, the axis of abscissa denotes positions of measured ridge portions which result when the relevant ridge portions are counted from the end portion which lies to the second cylindrical portion side. In FIG. 7, the axis of ordinates represents distances between the rack boots and the tie-rods.

As shown in FIG. 7, in the rack boot of the comparison example, the distance between the rack boot and the tie-rod was reduced drastically in the vicinity of a fourth ridge resulting when the ridge portions were counted from the end portion lying to the second cylindrical portion side. This indicates that a buckling was produced in the vicinity of the fourth ridge resulting when counted from the end portion lying to the second cylindrical portion side with the portion of the rack boot which lies in the vicinity of the fourth ridge sagging towards the direction of the tie-rod. In addition, the distance between the rack boot and the tie-rod was increased drastically from a fifth ridge onward, the fifth ridge resulting when counted from the end portion lying to the second cylindrical portion side. This indicates that a portion which was adjacent to the portion in the vicinity of the fourth ridge where buckling was produced expanded largely towards the outer circumferential side. It is seen from the result of the test that an abnormal deformation occurred in the rack boot of the comparison example.

In the rack boot of Embodiment 1, the distances between the ridge portions of the rack boot and the tie-rod were substantially equal. It is seen from the result of the test that neither buckling nor abnormal deformation occurred in the rack boot of Embodiment 1 even when the rack boot was compressed until the length thereof became minimum while the tie-rod was caused to swing its maximum level.

In addition, as shown in FIG. 7, the distance between the rack boot and the tie-rod was increased slightly in the portion which extends from the end portion lying to the second cylindrical portion to a second ridge resulting when the ridge portions were counted from the end portion lying to the second cylindrical portion (the second bellows portion) compared to the portion extending from a third ridge onward. This is because since the steering gearbox to which the second cylindrical portion is fixed stands still even when the tie-rod swings, the second bellows portion is fixed to the steering gearbox via the second cylindrical portion. It is seen from the result of the test that in the rack boot of the invention, in the event that at least the first bellows portion is formed into the tapered shape, an abnormal deformation is made difficult to occur even when the rack boot is compression deformed while swinging largely.

What is claimed is:

1. A rack boot comprising:
a hollow bellows portion in which radially outward rising ridge portions and radially inward sinking recess portions are formed alternately and continuously while the ridge portion and the recess portion which are adjacent to each other are connected together by an inclined wall portion;
a first cylindrical portion formed at one end of the bellows portion in such a manner as to be fixed to a tie-rod; and
a second cylindrical portion formed at the other end of the bellows portion in such a manner as to be fixed to a steering gear box,
wherein the bellows portion has a first bellows portion which makes up a portion extending from a third ridge of the ridge portions resulting when the ridge portions are counted from an end portion of the bellows portion which lies to the second cylindrical portion to the other end portion thereof which lies to the first cylindrical portion and a second bellows portion which makes up a portion extending from the third ridge to the end portion which lies to the second cylindrical portion, and
at least the first bellows portion is formed into a tapered shape in which an outside diameter of at least the ridge portions is such that an outside diameter of the ridge portion is made smaller than an outside diameter of the ridge portion which lies closer to the second cylindrical portion side.

2. A rack boot according to claim 1, wherein the second bellows portion is formed into the tapered shape.

3. A rack boot according to claim 1, wherein in the first bellows portion, an outside diameter of the recess portions is such that an outside diameter of the recess portion is made smaller than an outside diameter of the recess portion which lies closer to the second cylindrical portion side.

4. A rack boot according to claim 1, wherein in the first bellows portion, a difference in outside diameter between the ridge portions which lie adjacent to each other is in the range of 1 mm to 4 mm.

5. A rack boot according to claim 1, wherein in the first bellows portion, a difference in outside diameter between the recess portions which lie adjacent to each other is in the range of 1 mm to 4 mm.

6. A rack boot according to claim 1, wherein a ball joint is incorporated in the first bellows portion.

7. A rack boot according to claim 1, wherein the first bellows portion is made up of a smaller diameter side bellows portion and a larger diameter side bellows portion.

8. A rack boot according to claim 7, wherein the smaller diameter side bellows portion extends from an eighth ridge to the one end portion of the first bellows portion, and the larger diameter side portion extends from the third ridge to the eighth ridge.

9. A rack boot according to claim 1, wherein the outside diameters of the ridge portions of the second bellows portion are the same.

10. A rack boot according to claim 1, wherein the outside diameters of the recess portions of the second bellows portion are the same.

11. A steering rack comprising:
a steering gear box from which a rack bar extends;
a tie-rod;
a ball joint coupling the rack bar and the tie-rod;
a rack boot comprising:
a hollow bellows portion in which radially outward rising ridge portions and radially inward sinking recess portions are formed alternately and continuously while the ridge portion and the recess portion which are adjacent to each other are connected together by an inclined wall portion;
a first cylindrical portion formed at one end of the bellows portion in such a manner as to be fixed to the tie-rod; and
a second cylindrical portion formed at the other end of the bellows portion in such a manner as to be fixed to the steering gear box,
wherein the bellows portion has a first bellows portion which makes up a portion extending from a third ridge of the ridge portions to the other end portion thereof which lies to the first cylindrical portion and a second bellows portion which makes up a portion extending from the third ridge to the end portion which lies to the second cylindrical portion, and
the first bellows portion is formed into a tapered shape.

12. A steering rack according to claim 11, wherein said steering rack is configured so that a portion of the bellows portion which extends from the end portion thereof which lies to the second cylindrical portion to a second ridge of the ridge portions resulting when the ridge portions are counted from the end portion which lies to the second cylindrical portion deforms little even when the rack boot is compression deformed while swinging largely.
